(19) United States
(12) Patent Application Publication
(10) Pub. No.: US 2002/0034000 A1
(43) Pub. Date: Mar. 21, 2002

(54) Dual magnification for infrared imaging microscope

(76) Inventors: Robert Alan Hoult, Beaconsfield (GB); Ralph Lance Carter, Nr Thame (GB)

Correspondence Address: ST. ONGE STEWARD JOHNSTON & REENS, LLC, 986 BEDFORD STREET, STAMFORD, CT, 06905-5619, US

(21) Appl. No.: 09/942,184

(22) Filed: Aug. 29, 2001

(30) Foreign Application Priority Data
Aug. 29, 2000 (EP) 00307412.7

(51) Int. Cl. G02B 1/00

(52) U.S. Cl. 359/350; 359/354; 359/380

(57) ABSTRACT

An infrared imaging microscope, particularly of the type used to carry out FT-IR measurements, is provided with an assembly (40) which can be moved into or out of the beam propagating to the microscope detector (32) in order to change the magnification provided by the optical elements of the microscope. The assembly (40) can be located between the objective Cassegrain mirror (18) and the intermedite focus position (42) of that mirror. In one example the assembly includes first and second spherical mirrors (44, 45). The assembly can be mounted so as to be rotatably movable between its positions in or out of the beam.

This invention relates to an infrared imaging microscope, particularly of the type used to carry out FT-IR measurements.

A known apparatus of this type is an FT-IR microscope which is used to analyse small samples of material. The microscope has a viewing configuration and a measurement configuration. In both configurations the microscope can be used either in a transmitting mode or a reflecting mode depending upon the nature of the sample. Typically such a microscope is used in conjunction with an IR spectrophotometer. A microscope of this type generally includes a source of visible radiation and can receive analysing infrared radiation from a source in the spectrophotometer. A typical microscope includes a sample stage for carrying a sample to be investigated and optical elements for guiding radiation from one or other of the radiation sources to the sample stage. These elements can include a plain mirror, a toroid coupling optic and a Cassegrain mirror assembly acting as a condenser. The microscope also includes a Cassegrain mirror assembly which images the sample at a given magnification at an intermediate image plane from where the radiation is directed to an infrared detector. The microscope also includes an optical microscope which enables an image of the sample on the stage to be viewed optically by means of visible radiation and thereby enables areas of interest to be identified. The microscope can also include a video camera which can be used in conjunction with the optical microscope in order to create an image of the sample for display on a display means of a computer which is used to control the microscope.

Modem microscopes of this type have a stage which can be moved under computer control to allow several areas of interest to be identified, their coordinates stored and data collected subsequently automatically on the basis of that stored data. Such microscopes also include a variable aperture which can be computer controlled and is located at the intermediate image plane to mask off a portion of the sample. This combined with an oversized detector element enables the measurement of the infrared spectrum of the selected area of the sample. By stepping the stage and repeating the measurement, the system can slowly build up a digital image of the sample pixel-by-pixel.

In an alternative type of infrared microscope, the detector takes the form of an array of elements each contributing a pixel to the image. In this case, the variable aperture is not used and the pixel extent is determined by the physical size of the element.

The effective size of a pixel at the sample is determined by the overall magnification of the optical elements of the system in conjunction with the parameters of the variable aperture in one case, and the detector element in the other case. There is a need in such microscopes to provide a facility which enables the magnification to be varied on an automatic basis. Current microscopes which permit magnification changes rely upon manually operated arrangements, for example, ones which require the interchanging of the Cassegrain objectives or on the provision of a second sample position. The present invention is concerned with a microscope which provides a facility for changing the magnification automatically.

According to the present invention there is provided an infrared imaging microscope which includes a sample stage, optical elements for guiding analysing radiation to the sample stage and for directing radiation from a sample under investigation to a detector element or elements, said microscope including an assembly which can be moved into or out of the beam of radiation in order to change the magnification provided by the optical elements of the microscope.

The magnifying assembly may be located between the objective mirror of the microscope and its intermediate focus.

The magnifying assembly may include a reflecting element which in its operative position reflects the beam of radiation away from its normal direction of propagation and a magnifying component or components which can receive the reflected radiation.

The assembly may include first and second magnifying components the first of which receives radiation from the reflecting element and the second of which receives the radiation from the first magnifying component, and a second reflecting element for directing radiation from the second magnifying component along its normal direction of propagation. The first and second components may comprise spherical mirrors. The first and second reflecting elements may be plane mirrors.

The magnifying assembly may be movable between an operative and inoperative condition by rotation about an axis.

The assembly may be moved between an operative position in which the reflecting element is located in the beam of radiation and an inoperative position in which the radiation can propagate to the detector elements without magnification by the magnifying assembly by rotation about an axis through the first and second components. The angle of rotation through which the assembly can be rotated may be of the order of 90°.

The microscope may include a shield for shielding the detector from unwanted radiation, said shield being switchable between an operative and an inoperative position.

The shield may comprise an element disposed along the propagation path of radiation reflected from the first magnifying component to the second magnifying component, said element having therein an aperture and acting as a mask to prevent unrequited radiation arriving at the detector. Said element may comprise a plane mirror which allows through the aperture a beam of rays to be detected but blocks rays outside that beam.

The invention will be described now by way of example only, with particular reference to the accompanying drawings. In the drawings:

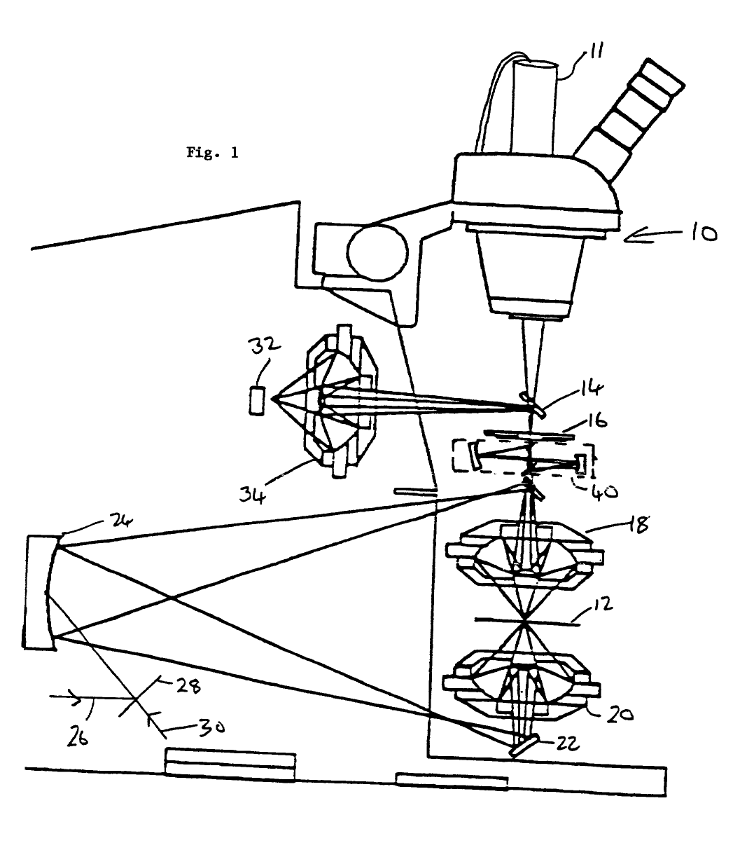

FIG. 1 is a side schematic view of an FT-IR microscope constructed in accordance with the present invention, and

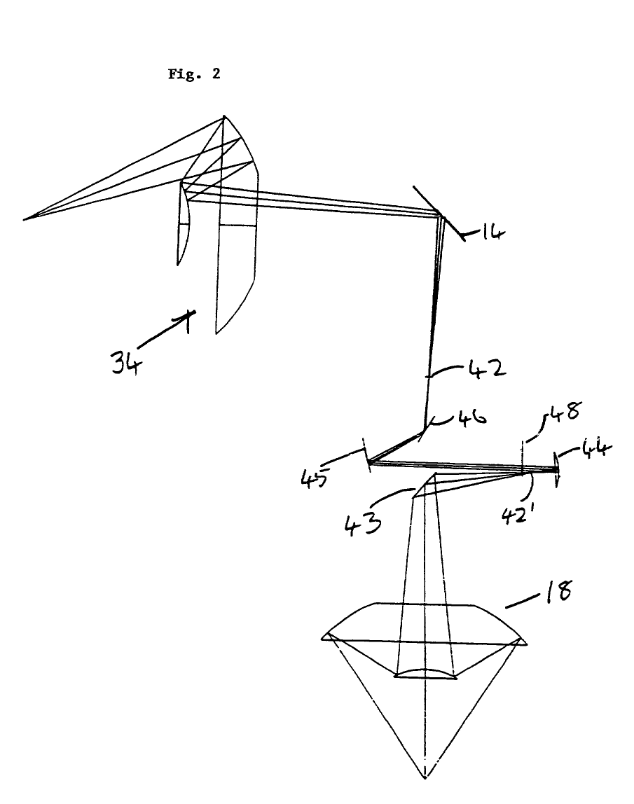

FIG. 2 is a more detailed view of a magnification assembly used in the microscope of FIG. 1;

FIG. 2a shows on an enlarged scale part of the assembly of FIG. 2, and

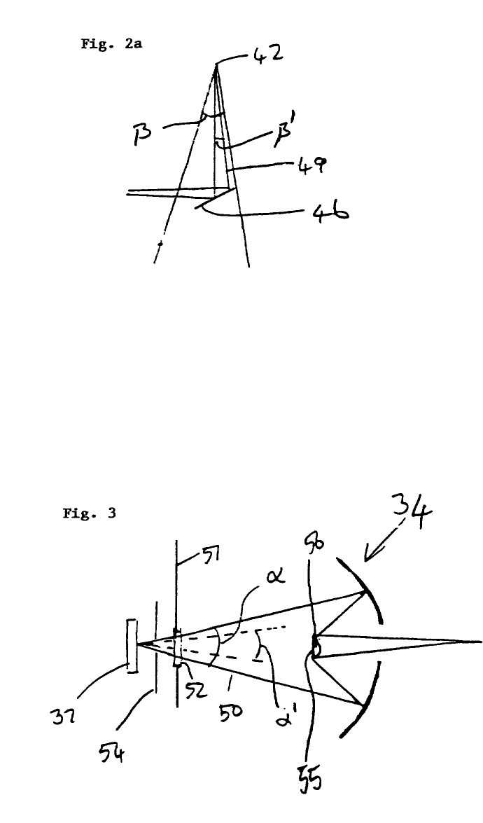

FIG. 3 illustrates the principle of a cold shield.

Referring to FIG. 1 there are shown the principal elements of an FT-IR microscope of an embodiment of the present invention. This microscope includes an optical microscope (10) which can be used to view a sample on a sample stage (12) through a dichroic mirror (14), a remote aperture (16) and an objective Cassegrain mirror assembly (18). The optical microscope can incorporate a video camera (11) which is coupled to a computer which controls the microscope. The video camera (11) can be used to create on the display device of the computer a video image of a sample under investigation. The microscope also includes a condenser Cassegrain lens assembly (20), a lower mirror (22) and a toroid reflector (24). The microscope can receive radiation from a source of infrared radiation (not shown) which may be located in an associated spectrophotometer. The incoming infrared beam (26) is directed by way of a flat dichroic mirror (28) towards the toroid reflector (24). The microscope includes a source of visible radiation (not shown) which can produce a beam (30) of visible radiation along a path which extends through the flat mirror (28). The visible radiation source can be mounted at a suitable location in the microscope.

A detector of infrared radiation such as an MCT detector (32) is disposed laterally from the dichroic mirror (14) and can receive infrared radiation reflected from that mirror by way of a detector Cassegrain mirror assembly (34). The way in which a microscope of this general form operates will be apparent to those skilled in the art and a description can be found for example in an article by D. W. Schiering, E. G. Young and T. P. Byron entitled “An FTIR microscope” published in American Laboratory, November 1990.

In microscopes of the present type the stage (12) is usually movable under computer control in at least horizontal plane so that areas of interest of a sample located on the stage (12) can be identified using a video image generated by the video camera (11) and data relating to those locations is stored in the computer. The computer then subsequently controls movement of the stage automatically to obtain measurements from the identified areas of the sample. A detailed description of a microscope incorporating this facility can be found in EP-A-0731371.

It will be seen that the present embodiment includes an assembly which is shown at (40) and is disposed in the beam of radiation propagating towards the remote aperture (16). This is an assembly which can be moved into or out of the beam of radiation in order to change the magnification provided by the microscope. The assembly is shown in more detail in FIG. 2 of the drawings and can be seen to be located between the objective Cassegrain (18) and the position (42) where that Cassegrain normally forms its intermediate image. The assembly includes the first planar mirror (43), a first generally spherical mirror (44), a second generally spherical mirror (45) and a second planar mirror (46). The elements (43 to 46) are formed as a single integral unit which can be rotated about a horizontal axis extending through the spherical mirrors (44 and 45). Thus the assembly can be rotated from the position shown in FIG. 2 of the drawings in which the mirror (43) deflects the beam of radiation propagating from the Cassegrain objective (18) towards the mirror (44), to a position in which the mirrors (46 and 43) lie in a common horizontal plane and are therefore disposed out of the beam of radiation propagating from the Cassegrain. The assembly also includes a planar reflector (48) which acts as a cold shield as will be described later.

With the assembly (40) in the position shown in FIG. 2 of the drawings, radiation emanating from the sample on the sample stage (12) is collected by the Cassegrain objective (18) and intercepted by the planar mirror (43) so that it is directed towards the spherical mirror (44) via a new intermediate focus (42). The radiation is then reflected by the spherical mirror (44) and propagates as a substantially parallel beam towards the second spherical mirror (45) before being reflected back towards the second planar mirror (46) and then focused at the original intermediate focus (42). It should be noted that the cold shield (48) has an aperture formed therein through which the parallel beam can pass. Thus, by inserting the assembly of components (44 to 46) into an operative position, the image is returned to the normal position (42) of the intermediate image, but has been magnified by the magnification factor provided by the two spherical mirrors (44 and 45). Typically this factor will be in the region of four.

The assembly of magnifying elements of the present embodiment are made up of four elements (44 to 46) and these can be conveniently aligned and held rigidly in an assembly which is separate from the other elements of the microscope and simply switched into or out of the radiation beam emanating from the objective Cassegrain (18) by a rotation step in order to provide an additional four times magnification whenever that is required. The rotation step through 90° is one example of a way in which the assembly can be switched into or out of the beam and is a particularly simply arrangement. It will be apparent to those skilled in the art that a simple rotation of this form can be automated using a simple motor in conjunction with two end stops. Only one of the end stops needs to be precisely located, namely that which is used to locate the elements in the position shown in FIG. 2. The stop which controls the positioning of the assembly at its non-operative position does not require such accurate location.

It will be seen from FIG. 2 and also particularly from FIG. 2a that when the assembly of magnifying elements is in its operative position, the cone of rays (β′) arriving at the intermediate focus (42) has a narrower cone angle than that of the cone of rays (β) arriving at the intermediate focus when the magnifying assembly is not in its operative position. It should be noted that FIG. 2a is intended to illustrate the different cone angles and is not necessarily to scale. The difference in cone angles is a natural consequence of providing increased magnification. It should be noted that the beam (49) provided by the components of the magnification assembly (40) is directed at an angle to the image plane following only one side of the original cone (β) rather than a scheme of routing rays near normal to the surface. This is because the rays close to the axial direction would be intercepted by the blind spot generated by the secondary of the detector Cassegrain (34) as can be appreciated from the rays emanating from the objective Cassegrain (18). In fact the proportions of the Cassegrain elements dictate that the extra magnification introduced by the assembly should be at least four times in order to keep the exit beam narrow enough to avoid vignetting by the detector Cassegrain secondary.

It will be appreciated that the arrangement shown in FIG. 2 is one example of a magnification assembly which can be used. Other combinations of mirrors are possible such as for example a spherical mirror and a flat mirror, or two parabolic mirrors or two ellipsoidal mirrors. However, while such aspheric mirrors may provide minor improvements in image quality, they are substantially more difficult and expensive to manufacture. It is also possible to use mirrors which are toroidal approximations to the ideal shape, these mirrors being a suitable compromise between cost and quality. It will also be appreciated that it is possible to use ray trace optimisation programs in order to generate optimum surface figures that are not true conic sections.

Other geometric arrangements of rays are possible. For example it is possible to employ a scheme similar to the one illustrated in FIG. 2, but located after the intermediate image (42). In such an arrangement the image presented as an input to the magnification stage would be real and the output would be virtual as opposed to the alternative arrangement which is illustrated in FIG. 2. In a further alternative the beam from the second spherical mirror could be directed below rather than above its input to create a C-beam geometry. This scheme is probably most advantageous in an arrangement comprising a combination of two parabolic mirrors chosen to minimise aberration in this configuration.

An important factor in all alternative arrangements is the need to control image aberration, maintaining the smallest practical angle between input and output beams at each of the curved mirrors in the magnification assembly.

As referred to above when the magnification assembly is in its operative position the beam of radiation propagating towards the intermediate focus (42) has a cone angle which is narrower than that when the magnification assembly is not in its operative position. This bundle of rays propagates to the detector (32) and the result is that the detector field of view is under-filled compared with the situation when the magnifying assembly is not operative. The detector, being an MCT type detector, is typically cooled to liquid nitrogen temperatures and is usually located in a Dewar type vessel. There is the possibility with the present arrangement of enhancing the signal-to-noise ratio in the 4× magnification situation by masking out room temperature photons arriving at the detector in the unused portions of its field of view. Whilst this could be achieved by a switched cold shield inside the detector to match the field of view which-exists when the 4× magnification is used this can be difficult to implement inside a Dewar container.

This will be explained initially by reference to FIG. 3. FIG. 3 shows schematically the MCI detector (32) receiving IR radiation (50) via the detector Cassegrain (34). The detector (32) is located within a Dewar vessel those wall is shown at (51) so that its temperature can be maintained at 77° K. Radiation to be detected enters the Dewar vessel through a window (52). A cold shield (54) is disposed between the window (52) and the detector (32) and operates to ensure that only radiation within cone angle α is incident on the detector. α is the cone angle of rays reflected from the mirror (14) when the magnification assembly (40) is not in its operative position. The cold shield (54) thus restricts the field of view of the detector (32) to that which is necessary to receive the incoming radiation (50) which is to be detected thereby substantially preventing infra red radiation from the relatively warm surrounding region from reaching the detector.

A typical detector (32) has a field of view matched to the input beam (50) at a focal ratio of about f/1. When the magnifying assembly is in its operative position the cone angle of the beam incident on the detector reduces to α′ as shown in FIG. 3. The angular spread of the beam now corresponds to approximately f/4. It can be seen that in this situation the detector can receive “warm” photons from the region between the cones α and α′. The cold shield used for cone angle-α is not appropriate for cone angle α′ since it allows in these warm photons.

The cold shield is located within the Dewar vessel and it is not a simple matter to provide within that vessel a switched cold shield which could cater for both cone angles.

We have recognised that it is possible to provide a switched cold shield using an appropriate optical component or components which are disposed externally of the Dewar vessel. Any such switched cold shield should operate to image the detector onto a cold object in that part of the field of view of the detector not used for the input beam and not covered by existing cold shield (54). This could be within the interior of the Dewar detector such as the detector itself and its immediate surroundings. As an example a mirror placed outside the Dewar vessel could be located to image the detector back on itself or onto an adjacent non-reflecting cold area. Such a mirror would require in it an aperture to allow through the beam (50).

FIG. 2 shows one way in which the cold shield can be implemented using the plane mirror (48).

With the magnification assembly of FIG. 2 it is possible to provide an effective cold shield externally of the Dewar in the following way. The planar mirror (48), in which is formed a through hole, is placed between the spherical mirror (44) and (45) as shown. The hole is so dimensioned to allow the parallel-beam of rays reflected from the first spherical mirror to pass through, but also to prevent rays outside that beams from propagating. More importantly, rays travelling in reverse through the system, but outside the illustrated beam, are reflected back on themselves by the plane mirror (48). The significance of this is that in unused parts of the detector field of view the detector sees in effect a reflection of itself or radiation emanating from a body at 77° K. rather than room temperature. 77° K. is typically the temperature inside a Dewar containing the MCT detector. Since the detector can have significant reflectivity it can be desirable to enhance this scheme further by tilting the plane mirror (48) slightly so that the detector images back to a spot adjacent to itself which may then be coated with a very low emissivity coating. The result is an externally switched cold shield which can minimise unwanted room temperature photons at both magnifications contributing to an improved signal-to-noise ratio.

It is also possible to improve cold shielding by minimising the effect of warm photons from other parts of the field of view of the detector. For example the rear surface (55) of the secondary mirror (56) of the detector Cassegrain assembly (34) is a source of such photons. This unwanted radiation can be effectively eliminated by placing a suitable concave spherical mirror on the rear surface (55) to augment the already described cold shielding. The input beam propagates from the annulus around the secondary mirror (56) so there is no need for any hole in this additional mirror. The effect of this additional cold shield will be most marked at the higher magnification although it will still have an effect at the lower magnification.

1. An infrared imaging microscope which includes a sample stage, optical elements for guiding analysing radiation to the sample stage and for directing radiation from a sample under investigation to a detector element or elements, said microscope including an assembly which can be moved into or out of the beam of radiation in order to change the magnification provided by the optical elements of the microscope.

2. A microscope according to claim 1, wherein said magnifying assembly is located between the objective mirror of the microscope and its intermediate focus.

3. A microscope according to claim 1 or claim 2, wherein the magnifying assembly includes a reflecting element which in its operative position reflects the beam of radiation away from its normal direction of propagation and a magnifying component or components which can receive the reflected radiation.

4. A microscope according to claim 3, wherein the magnifying assembly includes first and second magnifying components, the first of which receives radiation from the reflecting element and the second of which receives the radiation from the first magnifying component, and a second reflecting element for directing radiation from the second magnifying component along its normal direction of propagation.

5. A microscope according to claim 4, wherein the first and second components comprise spherical mirrors.

6. A microscope according to claim 4 or claim 5, wherein the first and second reflecting elements are plane mirrors.

7. A microscope according to any preceding claim, wherein the magnifying assembly is movable between an operative and an inoperative condition by rotation about an axis.

8. A microscope according to-any one of claims 4 to 7, wherein the assembly is movable between an operative position in which the reflecting element is located in the beam of radiation and an inoperative position in which the radiation can propagate to the detector elements without magnification by the magnifying assembly by rotation about an axis through the first and second components.

9. A microscope according to claim 7 or claim 8, wherein the angle of rotation through which the assembly can be rotated is of the order of 90°.

10. A microscope according to any preceding claim including a shield for shielding the detector from unwanted radiation, said shield being switchable between an operative and an inoperative position.

11. A microscope according to claim 10 when dependent upon any one or claims 4 to 9, wherein the shield comprises an element disposed along the propagation path of radiation reflected from the first magnifying component to the second magnifying component, said element having therein an aperture and acting as a cold shield to prevent unrequired radiation arriving at the detector.

12. A microscope according to claim 11, wherein said element comprises a plane mirror which allows through the aperture a beam of rays to be detected but blocks rays-outside that beam.

13. A microscope according to any preceding claim wherein the assembly is so arranged and constructed that the position of the intermediate focus is substantially unchanged when the assembly is moved into its operative position.
